(19) United States
(12) Patent Application Publication
(10) Pub. No.: US 2014/0359712 A1
(43) Pub. Date: Dec. 4, 2014

(54) ELECTRONIC APPARATUS AND CONTROL METHOD

(71) Applicant: Kabushiki Kaisha Toshiba, Tokyo (JP)

(72) Inventor: Masahiro Takayama, Hachioji-shi (JP)

(73) Assignee: Kabushiki Kaisha Toshiba, Tokyo (JP)

(21) Appl. No.: 14/258,383

(22) Filed: Apr. 22, 2014

(30) Foreign Application Priority Data
May 31, 2013 (JP) 2013-116345

(51) Int. Cl. H04L 29/06

(52) U.S. Cl. CPC H04L 63/08
USPC 726/4

(57) ABSTRACT

According to one embodiment, an electronic apparatus is configured to execute an environment selected from a plurality of environments comprising a first environment corresponding to a first account and a second environment corresponding to a second account different from the first account. The apparatus includes a first communication controller and a controller. The first communication controller communicates with an external device. The controller permits an execution of the second environment when the first communication controller communicates with the external device when the environment is selected from the plurality of environments.

### CROSS-REFERENCE TO RELATED APPLICATIONS

This application is based upon and claims the benefit of priority from Japanese Patent Application No. 2013-116345, filed May 31, 2013, the entire contents of which are incorporated herein by reference.

### FIELD

Embodiments described herein relate generally to an electronic apparatus and a control method.

### BACKGROUND

In recent years, bringing and using an information terminal etc. belonging to an employee in a company for business purposes (so-called a bring your own device (BYOD) scheme) attract attention. Various electronic apparatuses such as tablet terminals and smart phones can be used as the information terminal.

Realizing the BYOD scheme requires that various security measures be implemented with respect to the electronic apparatuses.

A virtual environment for a work account should not be used outside the office. However, even outside the office, it is sometimes necessary for the virtual environment for the work account to be used at a customer's place of business. But if the environment for the work account can be freely used, security becomes a problem, an example being the case where an electronic apparatus is stolen.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view illustrating an external appearance of an electronic apparatus according to an embodiment.

FIG. 2 is an exemplary diagram illustrating a structure of a system comprising the electronic apparatus according to the embodiment.

FIG. 3 is an exemplary block diagram illustrating a system structure of the electronic apparatus according to the embodiment.

FIG. 4 is an exemplary diagram illustrating an account selection screen.

FIG. 5 is an exemplary diagram illustrating a login screen.

FIG. 6 shows an example of the account selection screen.

FIG. 7 is an exemplary diagram illustrating the login screen.

FIG. 8 is an exemplary diagram illustrating the account selection screen.

FIG. 9 is an exemplary diagram illustrating the login screen.

FIG. 10 is an exemplary diagram illustrating processes executed by an account control program if a power button is operated.

### DETAILED DESCRIPTION

Various embodiments will be described hereinafter with reference to the accompanying drawings.

In general, according to one embodiment, an electronic apparatus is configured to execute an environment selected from a plurality of environments comprising a first environment corresponding to a first account and a second environment corresponding to a second account different from the first account. The apparatus includes a first communication controller and a controller. The first communication controller is configured to communicate with an external device. The controller is configured to permit an execution of the second environment when the first communication controller communicates with the external device when the environment is selected from the plurality of environments.

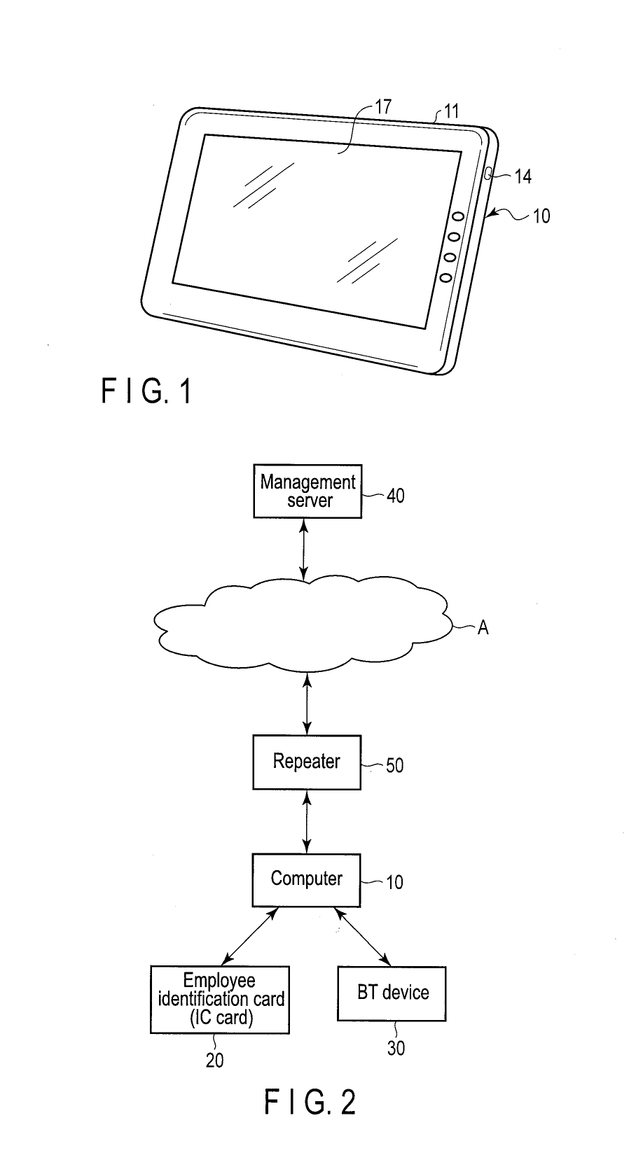

First, a structure of an electronic apparatus according to an embodiment will be described with reference to FIG. 1. The electronic apparatus can be realized as a portable terminal such as a tablet personal computer, a laptop or notebook personal computer and a PDA. Suppose the electronic apparatus is realized as a tablet personal computer 10 (hereinafter referred to as a computer 10).

FIG. 1 shows an external appearance of the computer 10. The computer 10 comprises a computer body 11 and a touch screen display 17. The computer body 11 comprises a thin box-shaped housing. A power button 14 for powering on/off the computer 10 is provided on a surface of the computer body 11. The touch screen display 17 is disposed on the surface of the computer body 11. The touch screen display 17 comprises a flat panel display (e.g., a liquid crystal display (LCD)) and a touch panel. The touch panel is provided to cover a screen of the LCD. The touch panel is configured to detect a position on the touch screen display 17 which is touched by a user's finger or a pen.

FIG. 2 shows a structure of a system comprising a computer.

The system comprises the computer 10, an employee identification card (an IC card) 20, a Bluetooth (registered trademark) device (BT device) 30, a management server 40, etc.

The employee identification card 20 is a contactless IC card corresponding to short-range wireless communications. The employee identification card 20 transmits a carrier from a near field communication (NFC) module provided in the computer, supplies a power to the employee identification card 20 by electromagnetic induction, and communicates between the NFC module and the employee identification card 20 by modulation of the carrier. Information unique to the employee identification card 20 is registered in the computer 10.

The BT device 30 is a device configured to communicate with a Bluetooth module provided in the computer 10. The BT device 30 corresponds to a proximity profile (PXP). Information unique to the BT device 30 is registered in the computer 10.

The management server 40 is connected to an Internet A. The computer 10 comprises a wireless communication module for communicating with the management server 40. The computer 10 communicates with the management server 40 through a repeater 50 and the Internet A.

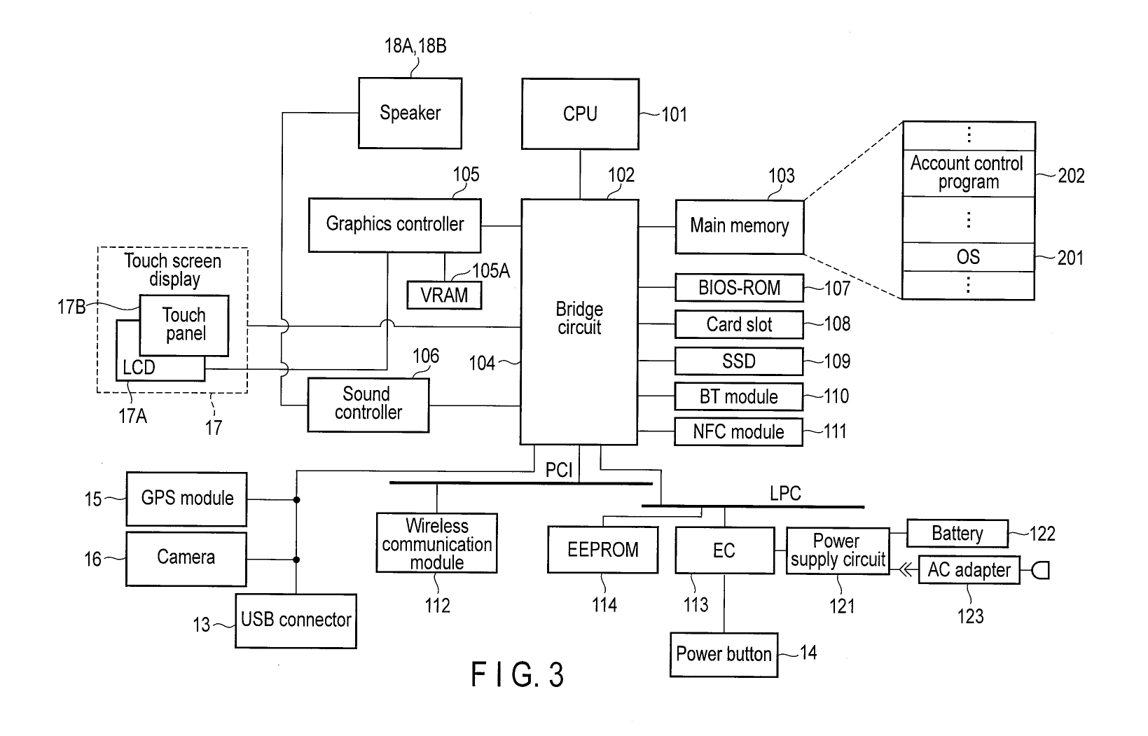

FIG. 3 is a block diagram illustrating an example of a system structure of the computer 10.

The computer 10 comprises a central processing unit (CPU) 101, a bridge circuit 102, a main memory 103, a graphics controller (GPU) 105, a sound controller 106, a BIOS-ROM 107, a card slot 108, a solid-state drive (SSD) 109, a Bluetooth module (BT module) 110, an NFC module 111, a wireless communication module 112, an embedded controller (EC) 113, an EEPROM 114, a USB connector 13, the touch screen display 17, a video memory (VRAM) 105A, the power button 14, etc.

The CPU 101 is a processor configured to control an operation of each of portions in the computer 10. The CPU 101 executes an operating system (OS) 201 and various application programs loaded from the SSD 109 which is a storage device into the main memory 103. The application programs comprise an account control program 202.

The CPU 101 also executes a Basic Input/Output System (BIOS) stored in the BIOS-ROM 107. The BIOS is a program for hardware control.

The bridge circuit 102 is a bridge device configured to connect between a local bus of the CPU 101, and each of devices on a peripheral component interconnect (PCI) bus and each of devices on a Low Pin Count (LPC) bus. Also, it comprises a serial Advanced Technology Attachment (ATA) controller for controlling the SSD 109. Moreover, it is configured to communicate with the sound controller 106, or to communicate with the GPU 105 through a serial bus etc. conforming to the PCI EXPRESS standard. Also, it comprises a Universal Serial Bus (USB) controller for controlling a Global Positioning System (GPS) module 15 and a camera 16.

The GPS module 15 receives a signal transmitted from at least four GPS satellites, and measures latitude and longitude of a current position based on the received signal.

The GPU 105 is a display controller configured to control an LCD 17A used as a display monitor of the computer 10. A video signal (also called a display signal) generated by the GPU 105 is transmitted to the LCD 17A.

The sound controller 106 is an audio source device and outputs audio data to be reproduced to speakers 18A and 18B. The BT module 110 is a wireless communication device conforming to the Bluetooth standard. The NFC module 111 is a short-range wireless communication device communicating with the employee identification card 20. The wireless communication module 112 is a wireless communication device configured to execute, for example, wireless communications conforming to the IEEE 802.11 standard, or mobile communications corresponding to a third-generation mobile telecommunications system (so-called 3G) or Long Term Evolution (LTE).

The EC 113 is an embedded controller configured to manage a power. The EC 113 is configured to power on/off the computer 10 in accordance with a user's operation of the power button 14. A power supply circuit 121 generates an operating power to be supplied to each of components using a power supplied from a battery 122 in the computer 10 or from an external power source such as an AC adapter 123. Also, the power supply circuit 121 charges the battery 122 using the power supplied from the external power source.

A touch panel 17B as well as the LCD 17A is incorporated into the touch screen display 17. The touch panel 17B provided on the LCD 17A comprises a sensor, a micro controller unit (MCU), etc. When a touch operation is performed on the touch panel 17B, the touched position is detected by the sensor, and input information comprising the touched position on the touch panel 17B is output by a touch controller.

A plurality of accounts can be set up on the computer 10. In this embodiment, three accounts, i.e., a home account, a work account and an alternative account are set up. The home account is an account for a user's private use. The work account is an account for business purposes. The computer 10 activates a virtual environment selected from a home environment corresponding to the home account, a work environment corresponding to the work account and an alternative environment corresponding to the alternative account. Each of the environments comprises an application program, data, etc. Access from the executed account environment to another account environment cannot be obtained. Minimal applications for using the computer 10 are stored in the alternative environment.

The work account is an account executed in business, and secret data used for business purposes is stored. The alternative account is an account which is not usually used. The alternative environment does not comprise much data. A degree of secrecy of the work account is higher than that of the alternative account.

If a power button is operated, the operating system 201 performs processing for displaying, on the LCD, an account selection screen for causing a user to select an environment (an account) to be activated. When the account selection screen is displayed, the account control program 202 performs activation control processing for making certain environments unselectable.

Home position information indicating a position of a user's home (hereinafter referred to as a home position) is associated with the home account. Also, company position information indicating a position of a company (hereinafter referred to as a company position) is associated with the work account.

If the power button is operated and a position measured by the GPS module 15 is within a predetermined range of the home position, the account control program 202 permits the operating system 201 to activate the home environment. Also, if the measured position is within the predetermined range of the home position, the account control program 202 prohibits the operating system 201 from activating the work environment and the alternative environment.

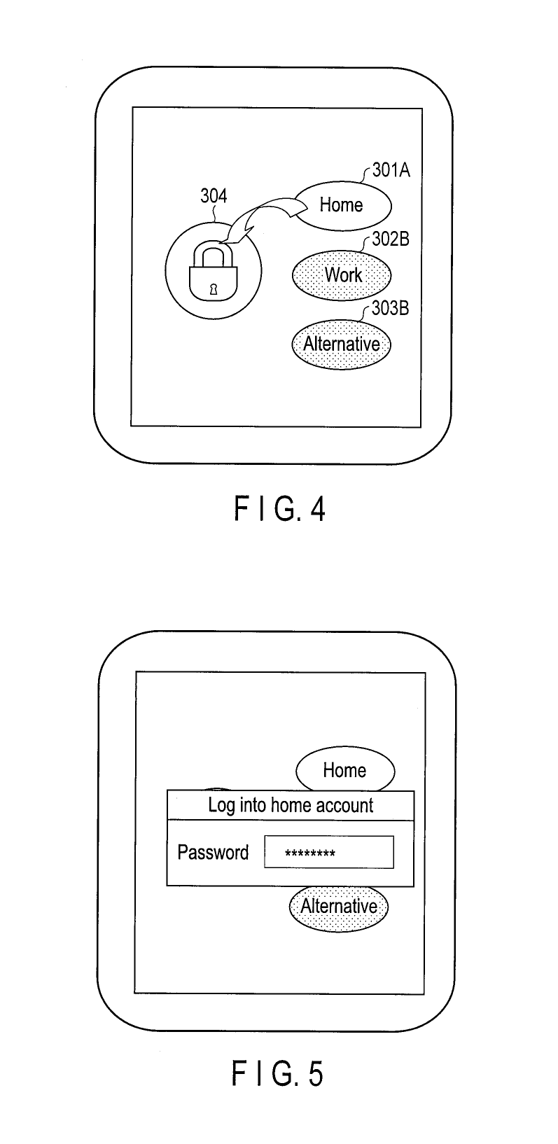

If activation of the home environment is permitted, the operating system 201 displays the account selection screen shown in FIG. 4. A home icon 301A, a job icon 302B, an alternative icon 303B and a login icon 304 are displayed as shown in FIG. 4. The job icon 302B and the alternative icon 303B are grayed out. The graying out of the job icon 302B and the alternative icon 303B enables a user to recognize that the work environment and the alternative environment are inaccessible. The user touches the home icon 301A and drags the home icon 301A to the login icon 304. The operating system 201 displays the login screen shown in FIG. 5 on the LCD 17A. The login screen of FIG. 5 indicates that the user is logging into the home account, and requests that a password be entered.

If the measured position is within a predetermined range of the company position, the account control program 202 permits the operating system 201 to activate the work environment. Also, if the measured position is within the predetermined range of the company position, the account control program 202 prohibits the operating system 201 from activating the home environment and the alternative environment.

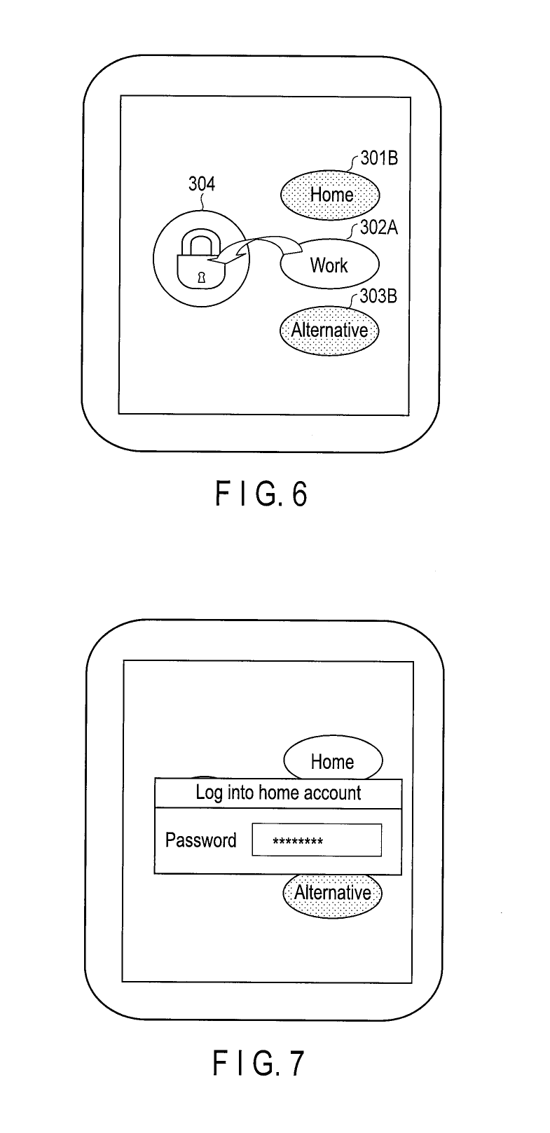

If activation of the work environment is permitted, the operating system 201 displays the account selection screen shown in FIG. 6. A home icon 301B, a job icon 302A, the alternative icon 303B and the login icon 304 are displayed as shown in FIG. 6. The home icon 301B and the alternative icon 303B are grayed out. The graying out of the home icon 301B and the alternative icon 303B enables the user to recognize that the home environment and the alternative environment are inaccessible. The user touches the job icon 302A and drags the job icon 302A to the login icon 304. The operating system 201 displays the login screen shown in FIG. 7 on the LCD 17A. The login screen of FIG. 7 indicates that the user is logging into the work account, and requests that a password be entered.

If the measured position is not within the predetermined range of the home position or the company position, or if the position cannot be detected, the account control program 202 prohibits the activation of the home environment and the work environment but permits that of the alternative environment. Also, if the measured position is not within the predetermined range of the home position or the company position, or if the position cannot be detected, the account control program 202 prohibits the operating system 201 from activating the home environment and the work environment.

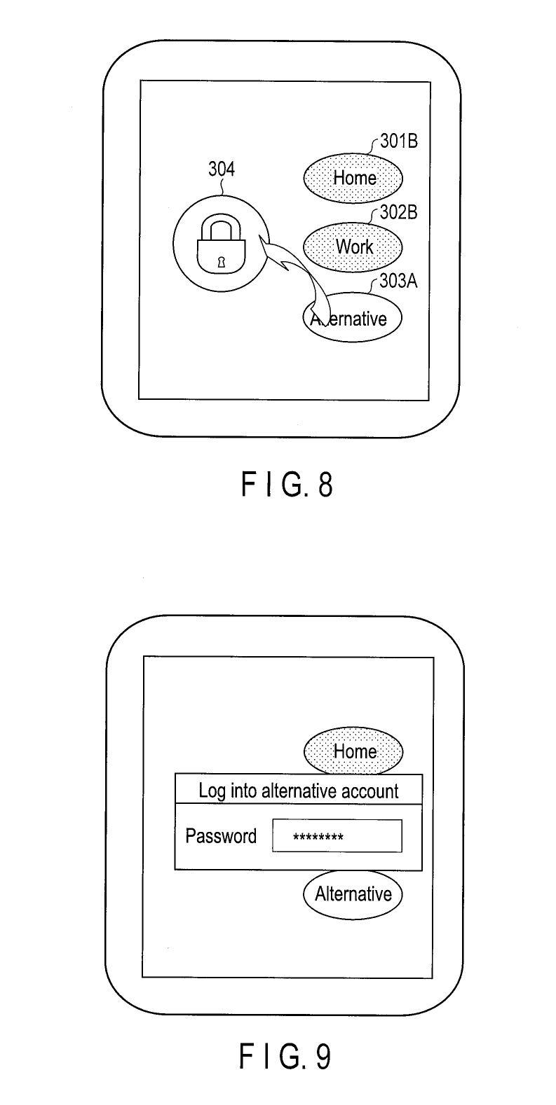

If activation of the alternative environment is permitted, the operating system 201 displays the account selection screen shown in FIG. 8. The home icon 301B, the job icon 302B, an alternative icon 303A and the login icon 304 are displayed as shown in FIG. 8. The home icon 301B and the job icon 302B are grayed out. The graying out of the home icon 301B and the job icon 302B enables the user to recognize that the home environment and the work environment are inaccessible. The user touches the alternative icon 303A and drags the alternative icon 303A to the login icon 304. The operating system 201 displays the login screen shown in FIG. 9 on the LCD 17A. The login screen of FIG. 9 indicates that the user is logging into the alternative account, and requests that a password be entered.

If activation of the alternative environment is permitted, the account control program 202 transmits data indicating status of use of the computer 10 to the management server 40. The data indicating the status of use is, for example, an image file taken by the camera 16. Also, the data is, for example, data indicating a position detected by the GPS module 15.

It should be noted that even in the case where the position cannot be detected if the computer 10 communicates with a preregistered external device, the account control program 202 permits the operating system 201 to activate the work environment.

The external device is, for example, an IC card or a Bluetooth device (BT device). If the NFC module 111 can communicate with a preregistered IC card, the account control program 202 permits the operating system 201 to activate the work environment. Alternatively, if the BT module corresponds to a proximity profile (PXP) and can communicate with the preregistered BT device, the account control program 202 permits the operating system 201 to activate the work environment.

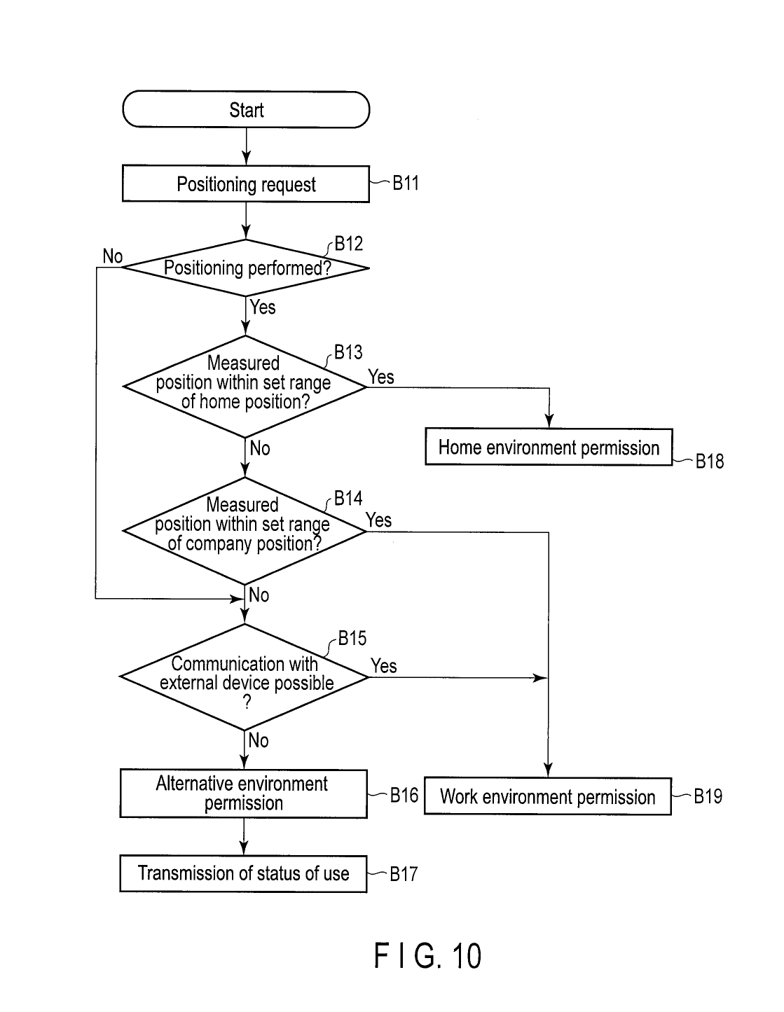

Processes executed by the account control program 202 if the power button is operated will be explained with reference FIG. 10.

The account control program 202 requests the GPS module 15 to perform positioning (step B11). When data indicating a result is received from the GPS module 15, the account control program 202 determines whether the positioning is performed or not (step B12). If it is determined that the positioning is performed (Yes in step B12), the account control program 202 determines whether the measured position is within a set range of the home position or not (step B13). If the measured position is within a set range of the home position (Yes in step B13), the account control program 202 notifies the operating system 201 of permission to activate the home environment (step B18). If it is determined that the measured position is not within a set range of the home position (No in step B13), the account control program 202 determines whether the measured position is within a set range of the company position or not (step B14). If it is determined that the measured position is within a set range of the company position (Yes in step B14), the account control program 202 notifies the operating system 201 of permission to activate the work environment (step B19). If it is determined that the measured position is not within a set range of the company position (No in step B14), or if it is determined that the positioning is not performed in step B12 (No in step B12), the account control program 202 determines whether the computer 10 can communicate with the external device (step B15). If it is determined that the computer 10 can communicate with the external device (Yes in step B15), the account control program 202 notifies the operating system 201 of permission to activate the work environment (step B19). If it is determined that the computer 10 cannot communicate with the external device (No in step B15), the account control program 202 notifies the operating system 201 of permission to activate the alternative environment (step B16). The account control program 202 transmits the status of use of the computer 10 to the management server 40.

It should be noted that if the GPS module 15 cannot perform the positioning, the positioning may be performed using the wireless communication module 112. If the wireless communication module 112 is a wireless communication device corresponding to the mobile communications, position information can be obtained from the repeater (a base station) 50. If the wireless communication module 112 is a wireless communication device conforming to the wireless communications of the IEEE 802.11 standard, a MAC address is obtained from the repeater (an access point or a router) 50, and the position information is obtained from a server in which the MAC address and the position of the access point 50 are registered.

In accordance with this embodiment, if communications can be performed with the employee identification card 20 or the BT device 30, the work environment corresponding to the work account having a high degree of secrecy can be activated at any place with security maintained by permitting the activation of the work environment.

If the alternative environment is activated, the computer 10 may have been lost or stolen. Transmission of data indicating the status of use of the alternative environment to the management server 40 enables a manager to specify a user and a use position.

It should be noted that all of procedures of control processing of this embodiment can be implemented by software. Thus, an advantage similar to that of this embodiment can be easily obtained merely by installing and executing a program for performing the control processing in a normal computer through a computer-readable storage medium storing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus configured to execute an environment selected from a plurality of environments comprising a first environment corresponding to a first account and a second environment corresponding to a second account different from the first account, the apparatus comprising:
a first communication controller configured to communicate with an external device; and
a controller configured to permit an execution of the second environment when the first communication controller communicates with the external device when the environment is selected from the plurality of environments.

2. The apparatus of claim 1, wherein the controller is configured to permit an execution of the first environment when communications with the external device fail to be performed.

3. The apparatus of claim 2, further comprising a second communication controller configured to communicate with the external electronic device connected to a network,
wherein the controller is configured to transmit data indicative of status of use of the apparatus to the external electronic device using the second communication controller when the first environment is executed.

4. The apparatus of claim 3, further comprising a measurement controller configured to detect a position of the apparatus,
wherein the data comprises position information indicative of the detected position of the apparatus.

5. The apparatus of claim 3, further comprising a camera,
wherein the data comprises an image file taken by the camera.

6. The apparatus of claim 1, further comprising a measurement controller configured to detect a position of the apparatus,
wherein the controller is configured to permit an execution of the second environment when the position detected by the measurement controller satisfies a first condition.

7. A control method of an electronic apparatus configured to execute an environment selected from a plurality of environments comprising a first environment corresponding to a first account and a second environment corresponding to a second account different from the first account, the method comprising:
permitting an execution of the second environment when a communication controller communicates with an external device when the environment is selected from the plurality of environments.

8. A computer-readable, non-transitory storage medium comprising a computer program configured to be executed by a computer configured to execute an environment selected from a plurality of environments comprising a first environment corresponding to a first account and a second environment corresponding to a second account different from the first account, the computer program configured to cause the computer to execute functions of:
permitting an execution of the second environment when the computer communicates with the external device when the environment is selected from the plurality of environments.
